(19) United States
(12) Patent Application Publication
(10) Pub. No.: US 2008/0187788 A1
(43) Pub. Date: Aug. 7, 2008

(54) System and method of operation of a fuel cell system and of ceasing the same for inhibiting corrosion

(76) Inventors: Richard G. Fellows, Vancouver (CA); Janusz Blaszczyk, Richmond (CA); Emerson R. Gallagher, Vancouver (CA); Andrew J. Henderson, Port Gentil (GA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/703,524

(22) Filed: Feb. 6, 2007

(51) Int. Cl. H01M 8/04; H01M 8/24

(52) U.S. Cl. 429/13; 429/22

(57) ABSTRACT

A fuel cell stack is provided having a plurality of fuel cells, each including a membrane electrode assembly interposed between anode and cathode flow field plates that form anode and cathode channels, respectively. An accumulating device is positioned downstream of the fuel cell stack. A purge control device is positioned downstream of the accumulating device operable in a first state to allow fluid communication between the anode and cathode channels, and in a second state to isolate an oxidant outlet from the accumulating device. Some embodiments include a purge control device between the anode channels and the accumulating device. A method of operation of the fuel cell stack includes selectively purging fluids from the fuel cell stack into the accumulating device at a first time and selectively purging fluids from the accumulating device at a second time, subsequent to the first time.

### CROSS-REFERENCE TO RELATED APPLICATIONS

This application claims the benefit under 35 U.S.C. §119(e) of U.S. Provisional Patent Application No. 60/______, filed Feb. 7, 2006 (formerly U.S. application Ser. No. 11/350,263, converted to provisional by petition filed Jan. 17, 2007), which applications are incorporated herein by reference in their entirety.

### BACKGROUND OF THE INVENTION

1. Field of the Invention

The present invention relates to electrochemical energy converters with ion exchange membranes, such as fuel cells or electrolyzer cells or stacks of such cells, and more particularly, to systems and methods for use with the same to prevent corrosion.

2. Description of the Related Art

Electrochemical fuel cells comprising ion exchange membranes, such as proton exchange membranes (PEMs) may be operated as fuel cells, wherein a fuel and an oxidant are electrochemically converted at the fuel cell electrodes to produce electrical power, or as electrolyzers, wherein an external electrical current is passed between the fuel cell electrodes, typically through water, resulting in generation of hydrogen and oxygen at the respective electrodes. FIGS. 1-4 collectively illustrate a typical design of a conventional membrane electrode assembly 5, an electrochemical fuel cell 10 comprising a PEM 2, a stack 100 of such fuel cells, and a fuel cell system 400.

Each fuel cell 10 comprises a membrane electrode assembly (“MEA”) 5 such as that illustrated in an exploded view in FIG. 1. The MEA 5 comprises a PEM 2 interposed between first and second electrode layers 1, 3 which are typically porous and electrically conductive, and each of which comprises an electrocatalyst at its interface with the PEM 2 for promoting the desired electrochemical reaction. The electrocatalyst generally defines the electrochemically active area of the fuel cell. The MEA 5 is typically consolidated as a bonded, laminated assembly.

In an individual fuel cell 10, illustrated in an exploded view in FIG. 2, an MEA 5 is interposed between first and second separator plates 11, 12, which are typically fluid impermeable and electrically conductive. The separator plates 11, 12 are manufactured from non-metals, such as graphite; from metals, such as certain grades of steel or surface treated metals; or from electrically conductive plastic composite materials.

Fluid flow spaces, such as passages or chambers, are provided between the separator plates 11 i 12 and the adjacent electrode layers 1, 3 to facilitate access of reactants to the electrode layers and removal of products. Such spaces may, for example, be provided by means of spacers between the separator plates 11, 12 and the corresponding electrode layers 1, 3, or by provision of a mesh or porous fluid flow layer between the separator plates 11, 12 and corresponding electrode layers 1, 3. More commonly, channels or flow fields are formed on the surface of the separator plates 11, 12 that face the electrode layers 1, 3. Separator plates 11, 12 comprising such channels are commonly referred to as fluid flow field plates. In conventional fuel cells 10, resilient gaskets or seals are typically provided around the perimeter of the flow fields between the faces of the MEA 5 and each of the separator plates 11, 12 to prevent leakage of fluid reactant and product streams.

Electrochemical fuel cells 10 with ion exchange membranes such as PEM 2, sometimes called PEM fuel cells, are advantageously stacked to form a stack 100 (see FIG. 3) comprising a plurality of fuel cells disposed between first and second end plates 17, 18. A compression mechanism is typically employed to hold the fuel cells 10 tightly together, to maintain good electrical contact between components, and to compress the seals. As illustrated in FIG. 2, each fuel cell 10 comprises a pair of separator plates 11, 12 in a configuration with two separator plates per MEA 5. Cooling spaces or layers may be provided between some or all of the adjacent pairs of separator plates 11, 12 in the stack 100. An alternate configuration (not shown) has a single separator plate, or “bipolar plate,” interposed between a pair of MEAs 5 contacting the cathode of one fuel cell and the anode of the adjacent fuel cell, thus resulting in only one separator plate per MEA 5 in the stack 100 (except for the end cell). Such a stack 100 may comprise a cooling layer interposed between every few fuel cells 10 of the stack, rather than between each adjacent pair of fuel cells.

The illustrated fuel cell elements have openings 30 formed therein which, in the stacked assembly, align to form fluid manifolds for supply and exhaust of reactants and products, respectively, and, if cooling spaces are provided, for a cooling medium. Again, resilient gaskets or seals are typically provided between the faces of the MEA 5 and each of the separator plates 11, 12 around the perimeter of these fluid manifold openings 30 to prevent leakage and intermixing of fluid streams in the operating stack 100.

Commercial viability of electrochemical systems or apparatus that include the electrochemical fuel cells 5 and/or the stack 100 may in some instances be hindered by corrosion of the stack during startup or shutdown or both. FIG. 4 illustrates a fuel cell system 400 including the fuel cell stack 100. At the time of startup, air may exist in anode channels 402 of the stack 100. Hydrogen is fed to the stack inlet on startup and corrosion can occur while there is air in the downstream portion of the anode channels 402 and hydrogen in the upstream portion. The duration of this corrosion event can be minimized or reduced by making the hydrogen front travel through the stack 100 at faster rates. Accordingly, methods have been developed to reduce corrosion in the stack.

In one method of reducing startup corrosion, generally applicable to automotive systems, an anode recycle blower is used to expedite the removal of excess fuel and/or inert fluids, which diffuse from the cathode chamber to the anode chamber, such as nitrogen, from the anode outlet and return them to the inlet. In another method, a large purge valve allows excess fuel and/or inert fluids in the anode chamber to be removed. However, these methods suffer from obstacles. For example, the anode recycle blowers are costly and generally unreliable, making their use expensive and their results unpredictable. The large purge valves are bulky and also expensive, introducing additional problems for use in limited spaces such as in automobiles. Additionally, large purge valves are capable of discharging fuel as well as inert fluids such as nitrogen.

An additional opportunity for corrosion to result in the stack 100 exists during shutdown of the stack 100. After shutdown, fuel such as hydrogen escapes from the anode chamber of each fuel cell by diffusion across the membrane 406 and is consumed in the cathode chamber of the same fuel cell. The anode pressure then drops and may absorb air through openings or channels in the MEA 5 or through leaks. This air can corrode elements of the fuel cell 10 or assembly components of the stack 100 or both upon startup of the stack 100. Previously proposed solutions to reduce corrosion during and after shutdown include introducing more hydrogen to the anode channels 402 or trying to avoid the leakage of air into the stack 100. However, using excess fuel such as hydrogen, which is not being used for the operation of an electrochemical system or apparatus, results in costly waste of fuel. Also, despite efforts to prevent leaks, it is not possible to completely avoid all leaks in all applications.

Commercial viability of fuel cells is also increasingly depending on fuel efficiency and hydrogen emissions. Existing solutions include single solenoid purge valves, which typically exhibit imprecise flow control, and water droplet and particulate fouling problems. Multiple purge valve arrays in turn are more expensive and have complex arrangements. Other solutions include control valves that operate similar to fuel injectors; however, these valves require more power and are generally complex to control. Metering devices are also used; however, these devices tend to experiences leakage, and are generally costly. Yet other solutions include a larger valve orifice followed by a flow restrictor having a small orifice, which is susceptible to water droplet or particulate fouling.

A system and/or method that is cost effective, compact, and reliable is needed to prevent corrosion formation during startup, shutdown, and load transients in electrochemical fuel cells and fuel cell stacks, and provide improved control over purging of fluids from the fuel cell stack.

### BRIEF SUMMARY OF THE INVENTION

According to one embodiment, an electrochemical system, comprises a plurality of fuel cells forming a fuel cell stack, each fuel cell comprising a membrane electrode assembly (MEA) having an ion exchange membrane interposed between an anode electrode layer and a cathode electrode layer, an anode flow field plate adjacent a first side of the MEA, the anode flow field plate adapted to direct a hydrogen-containing fuel to at least a portion of the first side of the MEA, and a cathode flow field plate adjacent a second side of the MEA, the cathode flow field plate adapted to direct an oxidant to at least a portion of the second side of the MEA, at least one accumulating device positioned downstream of the fuel cell stack and in fluid communication therewith, the accumulating device being operable to accumulate and dispense fluids, an oxidant outlet positioned downstream of the fuel cell stack, and a first purge control device positioned downstream of the accumulating device, the first purge control device being operable in a first state to allow fluid communication between at least a portion of the anode flow field plate and at least a portion of the cathode flow field plate and operable in a second state to isolate the oxidant outlet from the accumulating device.

According to one aspect of the above embodiment, the electrochemical system may further comprise a recirculation line in fluid communication with at least a portion of the fuel cell stack and operable to recirculate at least one fluid.

According to another embodiment, a method of ceasing operation of an electrochemical system having a plurality of fuel cells forming a fuel cell stack, each fuel cell comprising a membrane electrode assembly (MEA) having an ion exchange membrane interposed between anode and cathode electrode layers, an anode flow field plate positioned adjacent the anode electrode layer, the anode flow field plate adapted to direct a hydrogen-containing fuel from a fuel supply source to at least a portion of the anode electrode layer, a cathode flow field plate positioned adjacent the cathode electrode layer, the cathode flow field plate adapted to direct an oxidant from an oxidant supply source to at least a portion of the cathode electrode layer, and at least one accumulating device in fluid communication with at least a portion of at least one of the anode and cathode electrode layers, comprises disconnecting a primary load from the fuel cell stack, terminating the supply of fuel to the disconnected fuel cell stack, after terminating the supply of fuel, substantially consuming oxygen from air in the disconnected fuel cell stack to form oxygen-depleted air therein, and providing at least one of hydrogen and nitrogen from the accumulating device to at least a portion of at least one of the anode electrode layers.

According to yet another embodiment, a method of operation of an electrochemical system having a plurality of fuel cells forming a fuel cell stack, each fuel cell comprising a membrane electrode assembly (MEA) having an ion exchange membrane interposed between anode and cathode electrode layers, an anode flow field plate positioned adjacent the anode electrode layer and adapted to direct a hydrogen-containing fuel to the anode electrode layer, a cathode flow field plate positioned adjacent the cathode electrode layer and adapted to direct an oxidant to the cathode electrode layer, at least one accumulating device positioned downstream of the fuel cell stack, a cathode inlet positioned upstream of the fuel cell stack, an oxidant outlet positioned downstream of the fuel cell stack, a first purge control device positioned downstream of the accumulating device and operable in a first state to allow fluid communication between the anode flow field plates and the cathode flow field plates and in a second state to isolate the oxidant outlet from the accumulating device, and a second purge control device positioned between the fuel cell stack and the accumulating device, and operable in a first state to allow fluid communication between the anode flow field plates and the accumulating device and in a second state to cease fluid communication between the anode flow field plates and the accumulating device, comprises opening the second purge control device at a first time for operating in the first state to purge fluids from the anode flow field plates to the accumulating device upon detecting a fuel cell stack purge condition, closing the second purge control device for operating in the second state, and opening the first purge control device at a second time, subsequent to the first time, to purge fluids from the accumulating device to at least one of a surrounding environment and the cathode inlet, to conduct an accumulating device purge upon detecting an accumulating device purge condition.

According to still another embodiment, a method of operation of an electrochemical system having a plurality of fuel cells forming a fuel cell stack, each fuel cell comprising a membrane electrode assembly (MEA) having an ion exchange membrane interposed between anode and cathode electrode layers, an anode flow field plate positioned adjacent the anode electrode layer and adapted to direct a hydrogen-containing fuel to the anode electrode layer, a cathode flow field plate positioned adjacent the cathode electrode layer and adapted to direct an oxidant to the cathode electrode layer, at least one accumulating device positioned downstream of the fuel cell stack, a purge control device positioned between the fuel cell stack and the accumulating device, and operable in a first state to allow fluid communication between the anode flow field plates and the accumulating device and in a second state to cease fluid communication between the anode flow field plates and the accumulating device, comprises the steps of detecting an increase in a load applied to the fuel cell stack and an increase in a magnitude of at least one of a pressure and concentration of the oxidant in the fuel cell stack, and closing the purge control device for operating in the second state to increase at least one of a pressure and concentration of the hydrogen-containing fuel in the fuel cell stack and balance a pressure differential of the fuel cell stack.

According to a further embodiment, a method of operation of an electrochemical system having a plurality of fuel cells forming a fuel cell stack, each fuel cell comprising a membrane electrode assembly (MEA) having an ion exchange membrane interposed between anode and cathode electrode layers, an anode flow field plate positioned adjacent the anode electrode layer and adapted to direct a hydrogen-containing fuel to the anode electrode layer, a cathode flow field plate positioned adjacent the cathode electrode layer and adapted to direct an oxidant to the cathode electrode layer, at least one accumulating device positioned downstream of the fuel cell stack, a purge control device positioned between the fuel cell stack and the accumulating device, and operable in a first state to allow fluid communication between the anode flow field plates and the accumulating device and in a second state to cease fluid communication between the anode flow field plates and the accumulating device, comprises the steps of detecting a decrease in a load applied to the fuel cell stack and a reduction in a magnitude of at least one of a pressure and concentration of the oxidant in the fuel cell stack, and opening the purge control device for operating in the first state to reduce at least one of a pressure and concentration of the hydrogen-containing fuel into the fuel cell stack and balance a pressure differential of the fuel cell stack.

### BRIEF DESCRIPTION OF THE SEVERAL VIEWS OF THE DRAWING(S)

FIG. 1 is an exploded isometric view of a membrane electrode assembly according to the prior art.

FIG. 2 is an exploded isometric view of an electrochemical fuel cell according to the prior art.

FIG. 3 is an isometric view of an electrochemical fuel cell stack according to the prior art.

FIG. 4 is a block diagram of an electrochemical system according to the prior art.

FIG. 5 is a block diagram of an electrochemical system according to an embodiment of the present invention.

FIG. 6 is a block diagram of an electrochemical system according to another embodiment of the present invention.

FIG. 7A is a block diagram of an electrochemical system according to yet another embodiment of the present invention.

FIG. 7B is a block diagram of an electrochemical system in a first state of operation according to still another embodiment of the present invention.

FIG. 7C is a block diagram of the electrochemical system of FIG. 7B in a second state of operation.

FIG. 8 is a block diagram of an electrochemical system according to another embodiment of the present invention.

FIG. 9 is a block diagram of an electrochemical system according to yet another embodiment of the present invention.

FIG. 10 is a block diagram of an electrochemical system according to still another embodiment of the present invention.

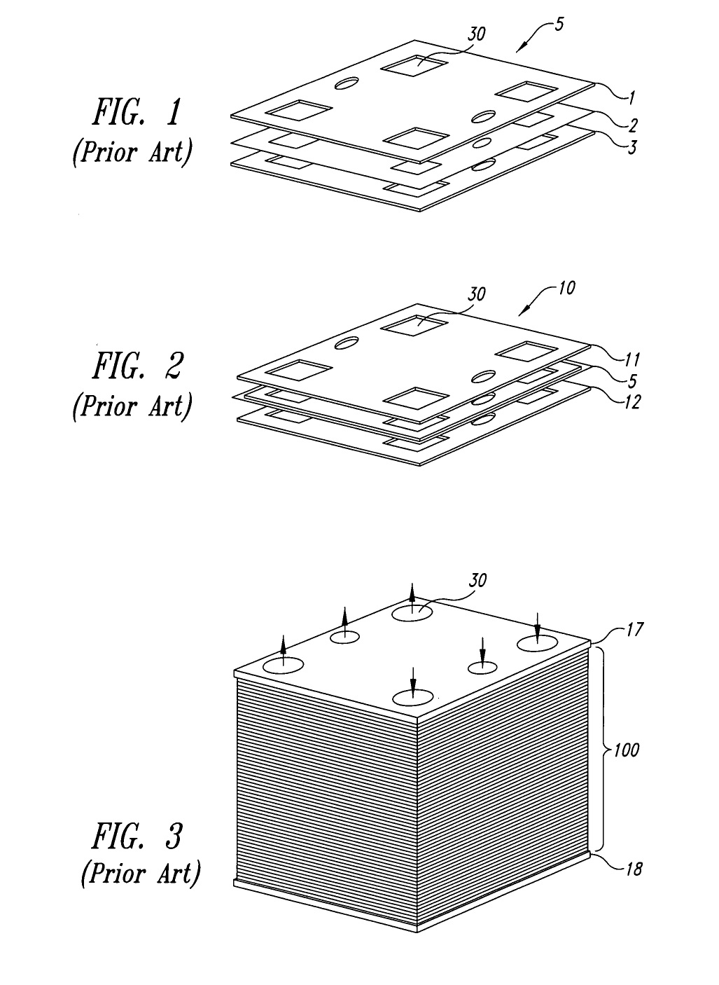

### DETAILED DESCRIPTION OF THE INVENTION

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with accumulators and diaphragms, and those associated with electrochemical fuel cell systems such as, but not limited to, flow field plates, end plates, electrocatalysts, external circuits, and/or recirculation devices have not been shown or described in detail to avoid unnecessarily obscuring descriptions of the embodiments.

Reference throughout this specification to “electrochemical systems”, “fuel cells”, “fuel cell stack”, “stack”, and/or “electrolyzers” is not intended in a limiting sense, but is rather intended to refer to any device, apparatus, or system wherein a fuel and an oxidant are electrochemically converted to produce electrical power, or an external electrical current is passed between fuel cell electrodes, typically through water, resulting in generation of hydrogen and oxygen at the respective electrodes.

Reference throughout this specification to “fuel” and/or “hydrogen” is not intended in a limiting sense, but is rather intended to refer to any reactant or gas separable into protons and electrons in a given chemical reaction to support electrochemical conversion to produce electrical power.

Reference throughout this specification to “oxidant”, “air”, and/or “oxygen” is not intended in a limiting sense, but is rather intended to refer to any liquid or gas capable of oxidizing such as, but not limited to, oxygen, water, water vapor, or air.

Reference throughout this specification to “ion exchange membrane”, “proton exchange membrane” and/or “PEM” is not intended in a limiting sense, but is rather intended to refer to any membrane, structure or material capable of allowing ions of a first charge or polarity to pass across the membrane in a first direction while blocking the passage in the first direction of ions of a second charge or polarity, opposite to the first charge or polarity.

Reference throughout this specification to “accumulating device”, “accumulating member”, “accumulating volume” and/or “accumulator” is not intended in a limiting a sense, but is rather intended to refer to any device, apparatus, container, at least partially bounded volume, or structure operable to receive and dispense a gas or to accumulate or store a charge of compressed gas.

Reference throughout this specification to “flow control device”, “purge valve”, “purge control device” and/or “valve” is not intended in a limiting a sense, but is rather intended to refer to any apparatus, valves, meters, computer controllers, or pumps or any device that can be used to manage the movement of a fluid from a first volume or location such as a fuel supply source to a second volume or location such as an electrode layer.

In one embodiment as illustrated in FIG. 5, an electrochemical system 500 is provided that includes a fuel cell stack 501 incorporating a plurality of fuel cells, each fuel cell having anode channels 502, cathode channels 504, and an ion exchange membrane 506, such as a PEM, interposed therebetween. A first flow control device 508 controls a feed flow rate of a fuel such as hydrogen from a fuel supply source 510 to the anode channels 502. A second flow control device 512 controls a feed flow rate of an oxidant such as oxygen or air, from an air supply source 514 to the cathode channels 504. Typically, the anode (or fuel) pressure is greater than the cathode (or oxidant) pressure during operation.

Upon introduction of the fuel to the system 500 from the fuel supply source 510, a first electrocatalyst layer at least partially contiguous to the anodes splits the hydrogen molecules into protons and electrons, the protons passing through the membranes 506 in a first direction while the electrons are routed to an external circuit, producing electrical power. The protons travel through the membranes 506 and through the cathode channels 504 to combine with the electrons returning from the external circuit and the oxygen fed to the cathodes from the air supply source 514 to generate water, heat and/or other by-products, which are purged from the system 500 as exhaust gas or liquid or both.

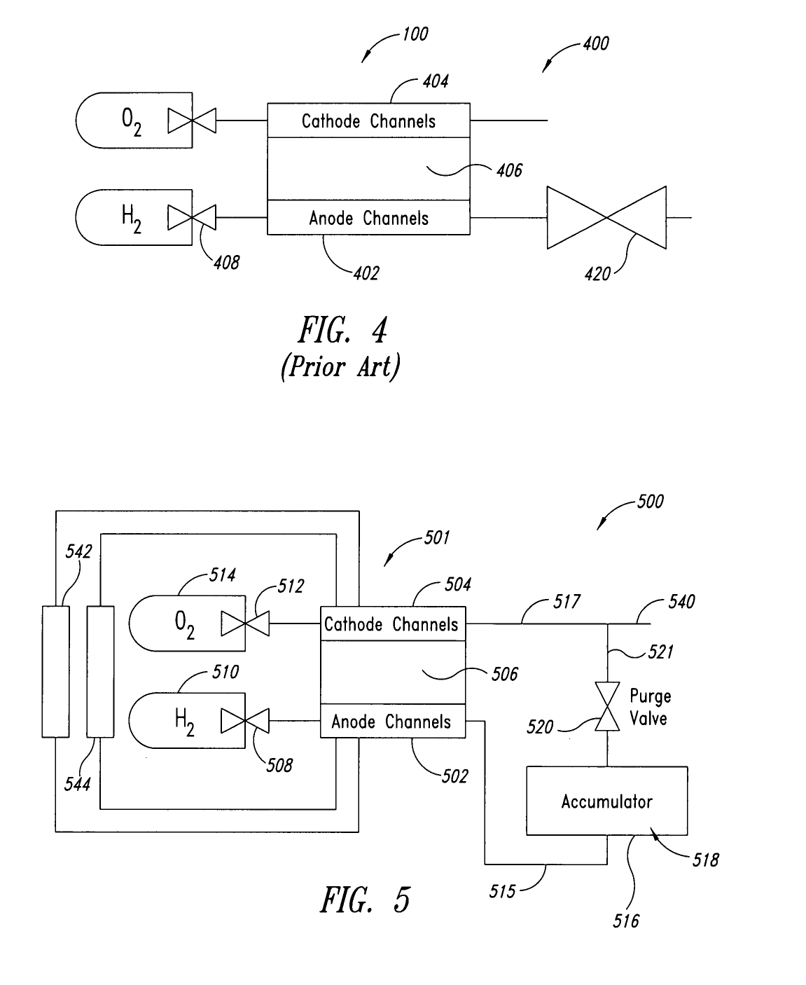

Referring to FIG. 4, at the time of startup of the existing fuel cell system 400, air may exist in the anode channels 402. Upon introduction of hydrogen to the anode channels 402, corrosion can occur if air remains in the downstream portion of the fuel cells.

In one embodiment of the present invention shown in FIG. 5, the fuel cell system 500 includes an accumulating device 516 having a volume 518 and positioned downstream of the stack 501. The accumulating device 516 is in fluid communication with at least one of the anode and cathode channels 502, 504 and may be an accumulator as shown in the illustrated embodiment of FIG. 5 or any device capable of receiving, storing, and dispensing at least one fluid, such as at least one of hydrogen, oxygen, and nitrogen, and/or accumulating and/or compressing the same.

When the first flow control device 508 is in the open position, the hydrogen-containing fuel flows from the fuel supply source 510 to the stack 501. Any air that may exist in the stack 501, especially in the anode channels 502, is forced out by the inflow of the hydrogen-containing fuel; and at least a portion of the air passively flows into the accumulating device 516.

The system 500 may further include a first purge control device 520, such as a purge valve having solenoids or a rotating disk, ball, or plug, or any other suitable flow control device, for releasing reactants, products and/or byproducts from the fuel cell stack 501. For example, when the system 500 ceases operation, air permeates into the anode channels 502 and corrosion may occur when fuel is introduced into the anode channels 502 and air is purged therefrom. In order to prevent corrosion, some existing fuel cell systems, such as the system 400 illustrated in FIG. 4, use a large purge valve 420 so that air in the anode channels 402 can be purged out quickly when fuel is introduced. Purge valves such as the large purge valve 420 of the system 400 typically include a large orifice because the purge rate of the air from the anode channels of the fuel cell stack of the system 400 is the same as the discharge rate of the air through the purge valve 420. However, large purge valves may inhibit the viability of fuel cell systems for a variety of applications such as vehicular applications, for example in automobiles. Additionally, large purge valves discharge large volumes of exhaust products including air and fuel, which can be wasteful and result in high hydrogen emissions.

In contrast, in the illustrated embodiment of FIG. 5, the first purge control device 520 does not need to have a large orifice for purging fluids such as air from the anode channels 502 in an expedited manner on startup. This is because the air that is forced out will flow into the volume 518 of the accumulating device 516.

Therefore, the accumulating device 516 provides for effective discharge of fluids such as air and/or other reactants, products, and inert gases such as nitrogen, from the stack 501 while preventing a large discharge of air, reactants and/or products to the surrounding environment. Reducing the discharge rate and volume of the exhaust products from the system 500 also minimizes or reduces the size of the first purge control device 520, adding to the feasibility of using the system 500 in applications in which space is limited.

The accumulating device 516 can be sized to maintain a desired volume of fluids being discharged from the first purge control device 520. An optimum level of fluids being discharged from the first purge control device 520 may be determined based on a given application and/or size requirements thereof. In the illustrated embodiment of FIG. 5, a purge line 521 extending from the first purge control device 520 is connected to an outlet stream 517 of the cathode channels 504, but may be, additionally or alternatively, connected to the air vent 540.

Furthermore, in some embodiments, a cross-sectional area of the accumulating device 516 may be greater than a cross-sectional area of a line, piping or any other component that communicates fluid flow to and/or from the accumulating device 516. Moreover, in some embodiments, the volume 518 of the accumulating device 516 may be approximately substantially identical to a total volume of the anode channels 502 of the fuel cell stack 501.

An additional opportunity for corrosion to occur is during shutdown of the existing system 400 shown in FIG. 4. After shutdown, the first flow control device 408, controlling a flow rate of fuel, is closed to minimize fuel consumption and fuel such as hydrogen is lost from the anodes by diffusion across the membranes 406 to the cathodes and by reaction with the remaining oxygen therein. The pressure of the anode channels 402 then plummets, causing the anodes to absorb air from the cathodes through openings or channels in the membranes 406, or through leaks. This air can lead to corrosion of the elements of the fuel cell system 400 and/or the assembly components of the fuel cell stack 100.

However, in the system 500 of an embodiment of the present invention, as the first flow control device 508 closes, the pressure in the anode channels 502 drops due to hydrogen diffusion from the anode channels 502 to the cathode channels 504 through the membranes 506 and reaction with the remaining oxygen in the cathode channels 504. Furthermore, the anodes will absorb some of the fluids from the accumulating device 516 downstream of the stack 501, which contains hydrogen-containing fuel and inert gases such as nitrogen, until the oxygen in the cathodes is substantially consumed. As hydrogen is drawn from the accumulating device 516 to the anode channels 502, air may be drawn from an air vent 540 and/or gases, such as oxygen-depleted air, may be drawn from the cathodes to replace the drawn hydrogen. At the same time, while a concentration of oxygen in the cathodes decreases, the first purge control device 520 may be opened such that the anode and cathode channels 502, 504 are at the same pressure, thus preventing air from crossing the membranes 506 from the cathode channels 504 to the anode channels 502.

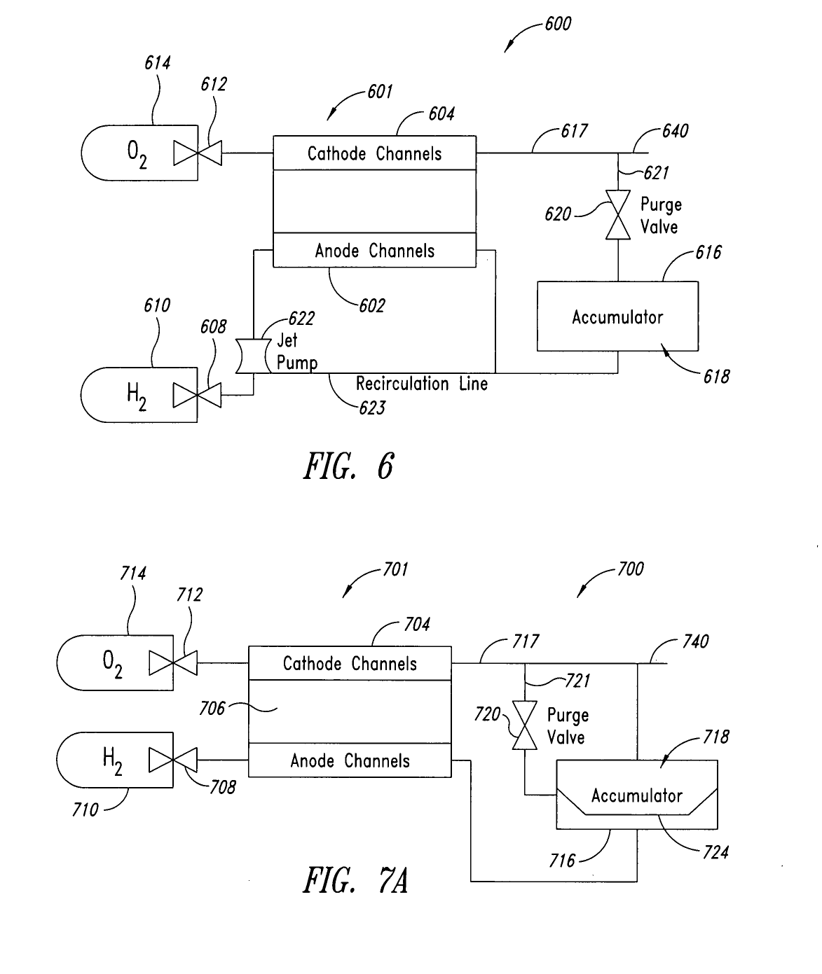

FIG. 6 illustrates an electrochemical system 600 according to another embodiment of the present invention in which a jet pump 622 is used to recirculate anode gases through a recirculation line 623 to assist in preventing gases or liquids such as nitrogen or water, respectively, from blocking the anode channels 602. The electrochemical system 600 further includes first and second flow control devices 608, 612 for controlling the flow rate of fuel and oxidant from the fuel supply source 610 and the oxidant supply source 614, respectively. The electrochemical system 600 may further include a first purge control device 620. In the illustrated embodiment of FIG. 6, the purge line 621 extending from the first purge control device 620 is connected to the outlet stream 617 of the cathode channels 604, but may be, additionally or alternatively, connected to the air vent 640.

Additionally, one of ordinary skill in the art will appreciate that the additional volume in an anode loop resulting from the accumulating device 616 may reduce pressure swings across the anode channels 602 (e.g., due to periodic purges of the anode if operating in a dead-ended mode of operation) by absorbing and discharging fluids in the anodes.

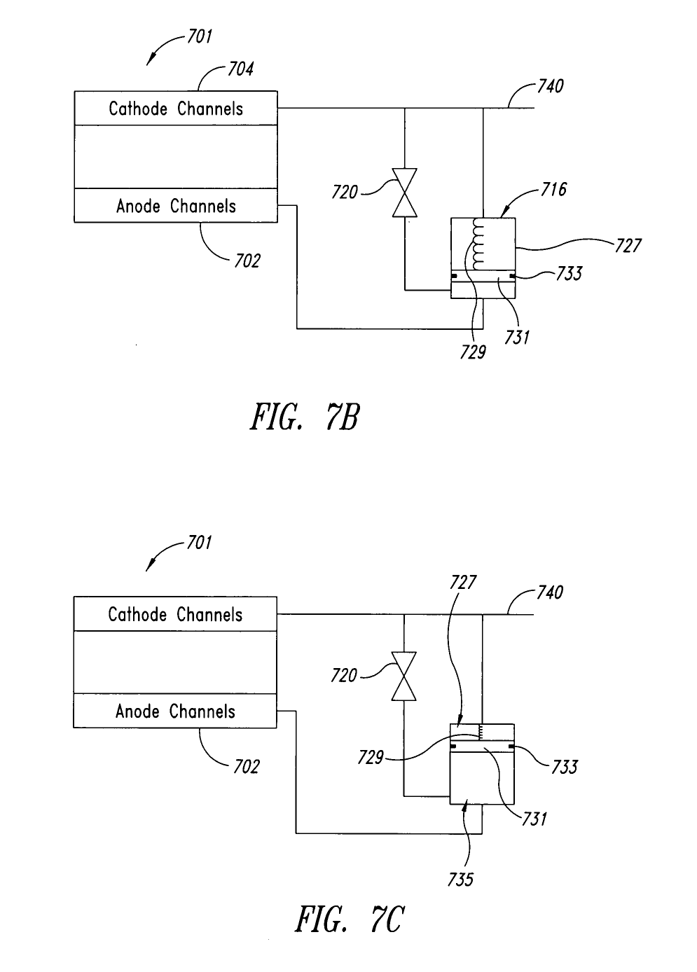

In yet another embodiment as illustrated in FIG. 7A, an electrochemical system 700 includes an accumulating device 716 having a volume 718 with a diaphragm 724 therein. The diaphragm 724 may be utilized to maintain a desired cross-pressure of the stack 701 (e.g., the pressure differential between the anode and the cathode) during normal operation, load transients, startups and/or shutdowns. Maintaining a desired cross-pressure of the stack 701 prevents unwanted pressure swings and/or vacuums that may result in hydrogen permeation through the membranes 706 or in air intake into the system 700 that can cause corrosion as described herein. Additionally, or alternatively, a position of the diaphragm 724 may control the feed fuel flow rate because it can give an indication of the cross-pressure. This information may be fed back to the fuel supply source 710 to either increase or decrease the flow rate of fuel, thus controlling the fuel flow rate and thereby regulating the cross pressure.

The electrochemical system 700 further includes first and second flow control devices 708, 712 for controlling the flow rate of fuel and air from the fuel supply source 710 and the air supply source 714, respectively. The electrochemical system 700 may further include a first purge control device 720. In the illustrated embodiment of FIG. 7A, the purge line 721 extending from the first purge control device 720 is connected to the outlet stream 717 of the cathode channels 704, but may be, additionally or alternatively, connected to the cathode inlet (e.g., upstream of cathode channels) or air vent 740.

As illustrated in FIG. 7B, in some embodiments, the accumulating device 716 and/or the diaphragm 724 may be or comprise a bias pressure device 727. The bias pressure device 727 may include any biasing member, such as a spring or an actuator 729, that can hold a piston 731 against the anode side, minimizing an anode volume. The piston 731 may comprise a seal 733 at a periphery thereof to prevent leaks. Without being bound by theory, in the event of a down transient (i.e., a reduction in load), the cathode pressure will drop, allowing the piston 731 to push toward the cathode side as shown in FIG. 7C. This increases a volume 735 of the accumulator 716 configured to fluidly communicate with the anode channels 702. Accordingly, a pressure of the anode channels 702 decreases, reducing a cross-pressure between the anode and cathode layers. Upon completion of the down transient as hydrogen is consumed and/or purged, the piston 731 at least substantially resumes its original position, illustrated in FIG. 7B.

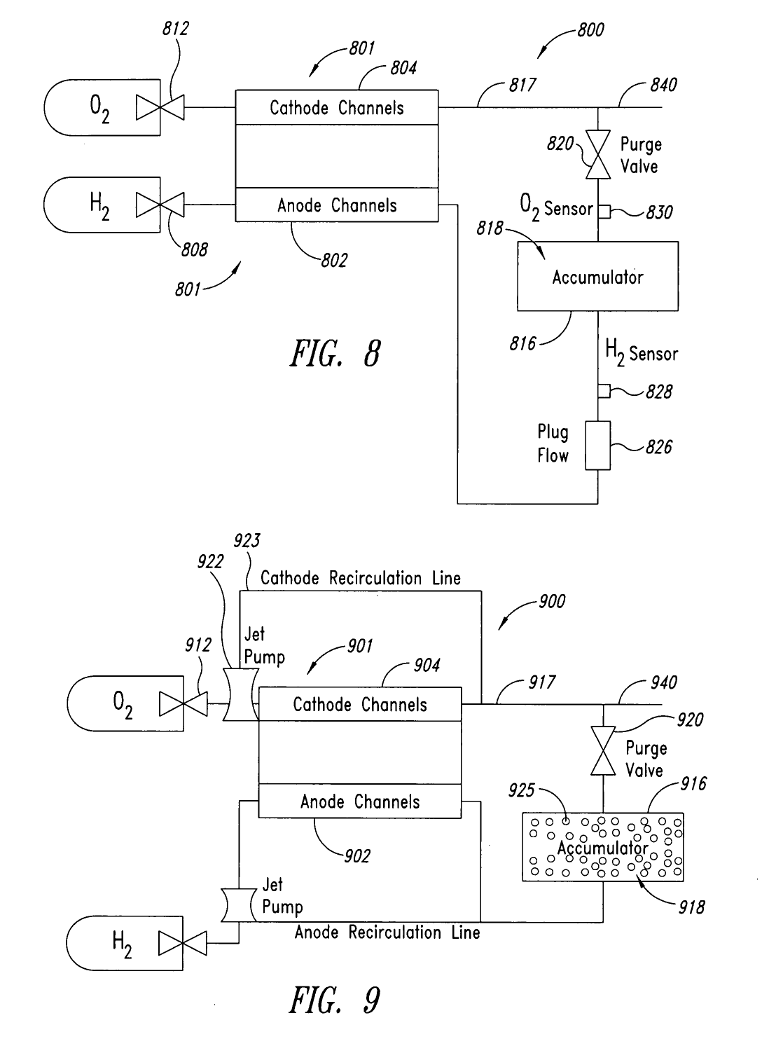

In still another embodiment as illustrated in FIG. 8, an electrochemical system 800 can be installed with a plug flow device 826 instead of, or in addition to, an accumulating device 816. The plug flow device 826 may be in fluid communication with the stream of gases discharged from the cathode channels 804 such that a cross-pressure of the stack 801 is passively regulated. The plug flow device 826 is usually narrow in cross-section with a high length to diameter ratio and usually contains purge gas at one end and air or cathode gas or both at the other end. The front between these two gases may shift during startup, shutdown, and/or load transients, thereby regulating the cross-pressure of the stack 801.

Additionally, a volume in which the gases can mix, such as a volume 818 of the accumulating device 816, may be positioned downstream of the plug flow device 826 to prevent an unexpected release of fuel into the cathode channels 804 or into the air vent 840.

Additionally, or alternatively, sensors 828, 830 such as oxygen or hydrogen sensors or both may be positioned in at least one line coupled to the plug flow device 826, or the accumulating device according to any of the foregoing embodiments or embodiments hereafter, to detect fluid compositions (for example, oxygen and hydrogen concentrations) of the gas. These sensors 828, 830 may selectively be positioned at different points in lines leading to or extending from the plug flow device 826 and may be electrically coupled to flow control devices 808, 812, which control the feed flow rate of a fuel such as hydrogen to anode channels 802 and/or the feed flow rate of an oxidant such as air to the cathode channels 804. The sensors 828, 830 may convey fluid composition information to the flow control devices 808, 812 to control the feed fuel flow rate or the feed air flow rate or both to the anode channels 802 and the cathode channels 804, respectively. Additionally, or alternatively, information from the sensors 828, 830 may be used to control the first purge control device 820, for example, closing the first purge control device 820 after shutdown is complete.

The inventors envision embodiments of the present invention that may or may not incorporate all the described components. For example, a system 800 that incorporates the plug flow device 826 may not necessarily incorporate the first purge control device 820. An individual of ordinary skill in the art, having reviewed this disclosure, will appreciate this and other variations that can be made to the system 800 without deviating from the scope of the invention.

It is understood that an electrochemical system according other embodiments of the present invention may include additional components or may exclude certain components described herein. For example, in a further embodiment illustrated in FIG. 9, an electrochemical system 900 includes an accumulating device 916 having a volume 918 and a gas-absorbing material or catalyst material 925 to assist in absorbing or reacting gases such as oxygen or hydrogen or both to the volume 918. For example, the material 925 may react with oxygen that is in the air that is drawn back in to the accumulating device 916 during shutdown to prevent oxygen from entering the anodes or cathodes.

Furthermore, the electrochemical system 900 may include a cathode recirculation line 923 similar to the anode recirculation line 623 discussed in conjunction with the illustrated embodiment of FIG. 6. According to one embodiment, a recirculation device 922 such as a jet pump or blower can be used to recirculate cathode gases through a recirculation line 923 and assist in preventing gases or liquids from blocking the cathode channels 904. Additionally, or alternatively, the oxidant can also be recirculated in the cathode recirculation line 923 while the oxygen is being substantially consumed from air inside the fuel cell stack 901 when the fuel cell stack 901 is disconnected. One of ordinary skill in the art will appreciate that anode and cathode recirculation lines can be incorporated in any of the embodiments described herein.

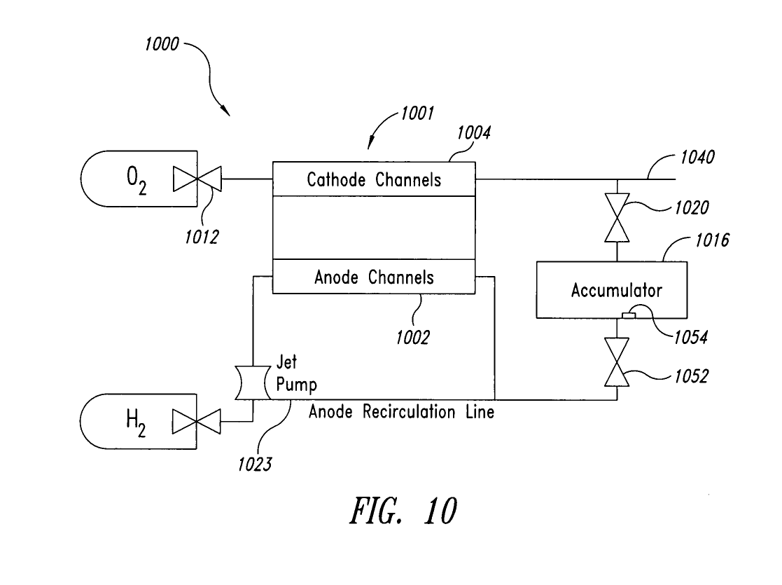

Furthermore, an electrochemical system 1000 according to yet another embodiment is illustrated in FIG. 10. The electrochemical system 1000 may include a first purge control device 1020 positioned downstream of the accumulating device 1016 and a second purge control device 1052 positioned downstream of anode channels 1002 and upstream of the accumulating device 1016. The second purge control device 1052 can be closed or opened and/or adjusted therebetween to maintain or vary a pressure of the fuel cell stack 1001, such as a pressure of the anode channels 1002. Furthermore, the second purge control device 1052 is configured to control and/or cease a flow of fluids between the anode channels 1002 and the accumulating device 1016.

In one embodiment, a method of operation of the electrochemical system 1000 comprises maintaining the first and second purge control devices 1020, 1052 in a closed state during normal operation of the fuel cell stack 1001. When it is desired to purge the fuel cell stack 1001, the first purge control device 1020 remains closed while the second purge control device 1052 is opened to pressurize the accumulator 1016. The first purge control device 1020 is then opened while the second purge control device 1052 is closed to discharge the accumulator 1016. In some embodiments, a sensor 1054, positioned within or proximate the accumulating device 1016, may trigger the purge of the fuel cell stack 1001. For example, the sensor 1054 can monitor and/or measure a magnitude of pressure in the accumulating device 1016 and trigger the purge upon detecting a threshold and/or predetermined pressure magnitude.

Additionally, or alternatively, the purge can be triggered based on a predetermined time interval, such as every minute or half a minute or any other suitable duration. In embodiments incorporating the pressure-based and/or time-based method of purging, the first and second purge control devices 1020, 1052 are not required to have a specific size or a specific dimension orifice with accurate tolerances because a specific volume of fluids, such as the hydrogen-containing fuel, is purged from the fuel cell stack 1001 during each purge condition.

In some embodiments, repetitive purging of the fuel cell stack 1001 may occur without opening the first purge control device 1020 when a fuel purge condition occurs. For example, during normal operations when the second purge control device 1052 is closed, a pressure differential is created between the anode channels 1002 and the accumulating device 1016. When the fuel purge is desired, the second purge control device 1052 can be opened purging fluids such as the hydrogen-containing fuel into the accumulating device 1016. Subsequently, when an accumulating device purge condition occurs, for example when the accumulating device 1016 is substantially filled with fluids and/or upon shutdown of the system 1000, the first purge control device 1020 can be opened to purge the accumulated fluids from the accumulating device 1016 to a surrounding environment, such as the atmosphere.

In yet other embodiments, the hydrogen-containing fuel released from the accumulating device 1016 may be purged into the cathode inlet, thereby reducing a concentration of hydrogen being released at once into the atmosphere.

In yet other embodiments, purge control devices 1020 and 1052 may be combined into a single 3-way valve with the common port attached to the accumulator 1016 and the other two ports to 1023 and 1040 (not shown).

One of ordinary skill in the art will appreciate that a second purge control device similar to that discussed above can be incorporated in any of the embodiments described herein and that the sensor 1054 may be configured to detect other parameters such as temperature and/or concentration of fluids instead or in addition to the pressure of fluids in the accumulating device before triggering the purge of the fuel cell stack and/or the accumulating device.

Additionally, or alternatively, the second purge control device 1052 can be used in some embodiments as a pressure-regulating device. For example, during an up transient or load increase, air pressure is typically increased. Accordingly, to match the increase in air pressure, it is desirable to increase a pressure of hydrogen in an expedited manner. Accordingly, the second purge control device 1052 is closed for a period of time during which the up load transient continues to reduce the volume of the anode loop, thereby increasing the rate at which the anode pressure rises.

Conversely, during a down transient or load decrease, air pressure is reduced to minimize parasitic power loss associated with an air compressor used to pressurize the air, which in turn can be the result of less water being produced. To match the decrease in air pressure, it is desirable to decrease a pressure of the hydrogen in an expedited manner to avoid unacceptably high cross-pressures in the fuel cell stack 1001. Accordingly, the second purge control device 1052 is opened for a period of time during which the down load transient continues, thereby releasing pressure in the anode channels 1002 as the hydrogen-containing fuel is biased from the anode channels 1002 to the accumulating device 1016 due to the pressure differential therebetween. To further reduce pressure, the first purge control device 1020 may be opened at the same time as the second purge control device 1052, or toggled back and forth between 1020 and 1052.

In other embodiments, a sensor may be configured to detect pressure changes in the oxidant and the second purge control device 1052 can be operated in a similar manner as described above to adjust a resulting pressure differential in the fuel cell stack 1001. Additionally, or alternatively, the pressure in the anode channels 1002 can be similarly monitored and when a threshold fuel or oxidant pressure and/or a desired cross-pressure between the anode and cathode layers is reached, the second purge control device 1052 may return to its normal condition depending on whether it was closed or opened to respond to an abnormal condition as described above.

In any of the above embodiments, pressure sensors (not shown) may be placed at inlets and/or outlets of the fuel cell stacks 501, 601, 701, 801, 901, 1001, for example, at the cathode inlet, cathode outlet, anode inlet, and/or anode outlet. The pressure sensors may be used to monitor a pressure of the gases, and the information from the pressure sensors may be used for controlling, for example, the air feed flow rate, the fuel feed flow rate, or the state of the first purge control device.

In any of the above embodiments, additionally or alternatively, the accumulating devices 516, 616, 716, 816, 916, 1016 may be included in an end hardware of the fuel cell stacks 501, 601, 701, 801, 901, 1001 instead of being an isolated device. An individual of ordinary skill in the art, having reviewed this disclosure, will appreciate these and other variations that can be made to the system without deviating from the spirit of the invention.

A method of ceasing operation of a fuel cell system, such as the one shown in FIG. 5, is described herein below. First, a primary load 542 is disconnected from the fuel cell stack 501. Next, the fuel supply 514 is terminated by closing the first flow control device 508 (which also isolates the fuel supply 514 from the stack 501). Oxygen in the air residing in the cathode channels 504 is consumed as hydrogen diffuses through the ion-exchange membranes 506 from the anode channels 502 to the cathode channels 504. The total volume of the anode channels 502, cathode channels 504, and accumulating device 516 should be appropriately sized such that a stoichiometric amount of hydrogen in the fuel residing in the anode channels 502 and accumulating device 516 compared with a stoichiometric amount of oxygen in the air residing in the cathode channels 504 is sufficient to substantially consume all of the oxygen in the cathode channels 504 upon shutdown of the fuel cell system 500 and, more preferably, with at least some excess hydrogen in the anode channels 502 after the oxygen is substantially consumed. In cases when the fuel cell stack 501 is operated with an anode overpressure during regular operation (for example, the anode pressure is greater than the cathode pressure), the first purge control device 520 may be opened when the anode pressure reaches or decreases below the cathode pressure (as determined by, for example, anode and cathode pressure sensors upstream and/or downstream of the fuel cell stack 501) as the hydrogen is depleted from the anode channels 502.

During operation, any excess fuel and/or other inert fluids that build up on the anodes is accumulated in the accumulating device 516. Thus, during shutdown of the fuel cell system 500, as hydrogen diffuses from the anode channels 502 and reacts with the remaining oxygen in the cathode channels 504 during oxygen consumption, excess fuel and/or other inert fluids in a fuel outlet line 515 and/or the accumulating device 516 will be drawn back into the anode channels 502 to replace the diffused hydrogen. Because the first purge control device 520 is initially closed during oxygen consumption, the anode pressure drops. When the anode pressure drops to and/or below the cathode pressure, the first purge control device 520 is opened so that air from the air vent 540 and/or air supply source 514 may be drawn back into the accumulating device 516 to replace the excess fuel and/or other inert fluids that was residing in the accumulating device 516, thus preventing a substantial vacuum from being created in the anode channels 502.

Additionally, because oxygen is being consumed from the cathode channels 504 during oxygen consumption, air may also be drawn back into the outlet line 517 and/or the cathode channels 504 to replace the oxygen that is consumed. The process continues until oxygen is substantially consumed from the cathode channels 504. As a result, hydrogen, nitrogen, or a mixture thereof, remains in the anode channels 502 after shutdown is complete, thereby preventing air (and oxygen) from being introduced into the anode channels 502. After the oxygen is substantially consumed in the fuel cell stack 501, shutdown of the fuel cell system 500 is complete.

As mentioned in the foregoing in conjunction with the illustrated embodiment illustrated in FIG. 9, the accumulating device 916 may further contain a material 925 that reacts with oxygen as air is drawn into the accumulating device 916 during hydrogen diffusion during shutdown. Thus, any oxygen that is in the air or cathode fluids that is drawn back into the accumulating device 916 and/or the cathode channels 904 will be reacted, thereby preventing oxygen from residing in the accumulating device 916 and, furthermore, preventing oxygen from entering the anode channels 902. In addition, the size of the accumulating device 916 may be minimized.

Additionally, an auxiliary load 544, illustrated in FIG. 5, may be connected to the fuel cell stack 501 to increase the rate of oxygen consumption of the oxygen residing in the cathodes. The power may be used to power any of the system components or vehicle devices, such as a radiator fan or blower, or may be stored into an energy storage device, such as a battery (not shown). One of ordinary skill in the art will recognize other system components that may also be used to consume the power, and will not be exemplified any further.

In another embodiment of a fuel cell system containing oxygen and/or hydrogen sensors positioned at different points in the lines leading to or extending from the accumulating device, such as the fuel cell system 800 as shown in FIG. 8, information from the oxygen and/or hydrogen sensors 828, 830 may be used to control the first purge control device 820. For example, the first purge control device 820 may be closed when a concentration of oxygen and/or hydrogen reaches and/or exceeds a pre-determined value during and/or after shutdown is complete.

In any of the embodiments discussed herein, the systems 500, 600, 700, 800, 900, 1000 may include a combustor or diluter (not shown) downstream of the first purge control devices 520, 620, 720, 820, 920, 1020 configured to consume or dilute the fluid stream exiting the accumulating devices 516, 616, 716, 816, 916, 1016 during or subsequent to a purge of the systems 500, 600, 700, 800, 900, 1000. In this manner, any remaining concentration of hydrogen will be consumed, making this embodiment more suitable for applications requiring strict emission standards.

Additionally, or alternatively, fluids exiting the respective accumulating devices 516, 616, 716, 816, 916, 1016 may be purged to the respective oxidant inlet downstream of the second flow control devices 512, 612, 712, 812, 912, 1012 via a purge line downstream of the accumulating devices 516, 616, 716, 816, 916, 1016 and/or first purge control devices 520, 620, 720, 820, 920, 1020. In these embodiments, the purge line can be connected to the line upstream of the cathode channels 504, 604, 704, 804, 904, 1004. Such an arrangement also prevents a large release of hydrogen from the accumulator to the atmosphere during a purge of the systems 500, 600, 700, 800, 900, 1000 without a need to use a combustor or diluter.

In any of the foregoing embodiments, the second flow control devices 512, 612, 712, 812, 912, 1012 may be opened or closed during the shutdown process.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims and their equivalents.

1. An electrochemical system, comprising:
a plurality of fuel cells forming a fuel cell stack, each fuel cell comprising:
a membrane electrode assembly (MEA) having an ion exchange membrane interposed between an anode electrode layer and a cathode electrode layer;
an anode flow field plate adjacent a first side of the MEA, the anode flow field plate adapted to direct a hydrogen-containing fuel to at least a portion of the first side of the MEA; and
a cathode flow field plate adjacent a second side of the MEA, the cathode flow field plate adapted to direct an oxidant to at least a portion of the second side of the MEA;
at least one accumulating device positioned downstream of the fuel cell stack and in fluid communication therewith, the accumulating device being operable to accumulate and dispense fluids;
an oxidant outlet positioned downstream of the fuel cell stack; and
a first purge control device positioned downstream of the accumulating device, the first purge control device being operable in a first state to allow fluid communication between at least a portion of the anode flow field plate and at least a portion of the cathode flow field plate and operable in a second state to isolate the oxidant outlet from the accumulating device.

2. The electrochemical system of claim 1, further comprising:
a first flow control device positioned upstream of the fuel cell stack and configured to selectively control a flow rate of the hydrogen-containing fuel from a fuel supply source to the anode electrode layer of the fuel cells; and
a second flow control device positioned upstream of the fuel cell stack and configured to selectively control a flow rate of the oxidant from an oxidant supply source to the cathode electrode layer of the fuel cells.

3. The electrochemical system of claim 2, further comprising at least one sensor positioned proximate the accumulating device and electrically coupled to at least one of the first and the second flow control devices, the at least one sensor being operable to measure a concentration of at least one of hydrogen and oxygen down stream of the fuel cell stack and to electrically communicate an indication of at least one of the hydrogen concentration and the oxygen concentration to the at least one of the first and the second flow control devices to control a flow rate of at least one of the hydrogen-containing fuel and the oxidant.

4. The electrochemical system of claim 1 wherein the at least one accumulating device includes a diaphragm operable to maintain at least one of a cross-pressure of the fuel cell stack and a feed flow rate of at least one of the hydrogen-containing fuel and the oxidant, the diaphragm including a bias pressure device configured to increase a volume of the accumulating device in fluid communication with the anode electrode layers in response to a decrease in a pressure of the cathode channels.

5. The electrochemical system of claim 1 wherein the at least one accumulating device further comprises a gas-absorbing material.

6. The electrochemical system of claim 1 wherein the at least one accumulating device further comprises a material capable of at least one of oxidation and reduction upon reacting with an oxidant.

7. The electrochemical system of claim 1, further comprising:
at least one recirculation line upstream of the purge control device and operable to recirculate at least one of a portion of a fuel stream and a portion of an oxidant steam.

8. The electrochemical system of claim 7, further comprising:
a device operable to expedite the recirculation of at least one of the portion of the fuel stream and the portion of the oxidant stream.

9. The electrochemical system of claim 7 wherein the accumulating device includes at least one catalyst for reacting at least two gases.

10. The electrochemical system of claim 1 wherein the at least one accumulating device comprises at least one of a plug flow device and a biasing member comprising at least one of a spring and an actuator.

11. The electrochemical system of claim 1, further comprising:
a second purge control device positioned downstream of the anode channels and upstream of the accumulating device, the second purge control device being configured to control a flow of fluids between the anode channels and the accumulating device.

12. A method of ceasing operation of an electrochemical system having a plurality of fuel cells forming a fuel cell stack, each fuel cell comprising a membrane electrode assembly (MEA) having an ion exchange membrane interposed between anode and cathode electrode layers, an anode flow field plate positioned adjacent the anode electrode layer, the anode flow field plate adapted to direct a hydrogen-containing fuel from a fuel supply source to at least a portion of the anode electrode layer, a cathode flow field plate positioned adjacent the cathode electrode layer, the cathode flow field plate adapted to direct an oxidant from an oxidant supply source to at least a portion of the cathode electrode layer, and at least one accumulating device in fluid communication with at least a portion of at least one of the anode and cathode electrode layers, the method comprising the steps of:
disconnecting a primary load from the fuel cell stack;
terminating the supply of fuel to the disconnected fuel cell stack;
after terminating the supply of fuel, substantially consuming oxygen from air in the disconnected fuel cell stack to form oxygen-depleted air therein; and
providing at least one of hydrogen and nitrogen from the accumulating device to at least a portion of at least one of the anode electrode layers.

13. The method of claim 12 wherein the accumulating device is a plug flow device and the method further comprises the step of passively accumulating and dispensing at least one of hydrogen, oxygen, and nitrogen in and from the plug flow device, respectively.

14. The method of claim 12 wherein the accumulating device comprises a material capable of oxidizing or reducing upon reacting with oxygen and the method further comprises the step of reacting the material with oxygen drawn to the accumulating device.

15. The method of claim 12 wherein the accumulating device comprises a diaphragm including a bias pressure device configured to increase a volume of the accumulating device in fluid communication with the anode channels in response to a decrease in a pressure of the cathode channels, and the method further comprises the step of:
adjusting the volume of the accumulating device to maintain a cross-pressure of the fuel cell stack in response to a position of the bias pressure device.

16. The method of claim 12 wherein the electrochemical system further comprises at least one flow control device downstream of the fuel cell stack and in fluid communication with the fuel cell stack and the accumulating device, and the method further comprises the step of:
opening the at least one flow control device when an anode pressure is equal to or less than a cathode pressure of the fuel cell stack prior to or during substantially consuming the oxygen in the air in the fuel cell stack.

17. The method of claim 12, further comprising the step of:
connecting an auxiliary load to the disconnected fuel cell stack to consume the oxygen in the air therein.

18. The method of claim 12 wherein the electrochemical system further comprises a recirculation line upstream of the accumulating device and operable to recirculate at least one of a portion of a fuel stream and a portion of an oxidant stream, and the method further comprises the step of:
recirculating at least one of the portion of the fuel stream and the portion of the oxidant stream.

19. The method of claim 16, further comprising the step of:
detecting a concentration of at least one of hydrogen and oxygen and communicating an indication of the at least one of the hydrogen concentration and the oxygen concentration to the at least one flow control device.

20. A method of operation of an electrochemical system having a plurality of fuel cells forming a fuel cell stack, each fuel cell comprising a membrane electrode assembly (MEA) having an ion exchange membrane interposed between anode and cathode electrode layers, an anode flow field plate positioned adjacent the anode electrode layer and adapted to direct a hydrogen-containing fuel to the anode electrode layer, a cathode flow field plate positioned adjacent the cathode electrode layer and adapted to direct an oxidant to the cathode electrode layer, at least one accumulating device positioned downstream of the fuel cell stack, a cathode inlet positioned upstream of the fuel cell stack, an oxidant outlet positioned downstream of the fuel cell stack, a first purge control device positioned downstream of the accumulating device and operable in a first state to allow fluid communication between the anode flow field plates and the cathode flow field plates and in a second state to isolate the oxidant outlet from the accumulating device, and a second purge control device positioned between the fuel cell stack and the accumulating device, and operable in a first state to allow fluid communication between the anode flow field plates and the accumulating device and in a second state to cease fluid communication between the anode flow field plates and the accumulating device, the method comprising the steps of:
opening the second purge control device at a first time for operating in the first state to purge fluids from the anode flow field plates to the accumulating device upon detecting a fuel cell stack purge condition;
closing the second purge control device for operating in the second state; and
opening the first purge control device at a second time, subsequent to the first time, to purge fluids from the accumulating device to at least one of a surrounding environment and the cathode inlet, to conduct an accumulating device purge upon detecting an accumulating device purge condition.

21. The method of claim 20, further comprising:
detecting a magnitude of at least one operating parameter of the fuel cell stack;
comparing the magnitude of the at least one operating parameter of the fuel cell stack to a first threshold magnitude thereof to determine an existence of the fuel cell stack purge condition; and
initiating a fuel cell stack purge when the magnitude of the at least one operating parameter of the fuel cell stack is substantially identical to or surpasses the first threshold magnitude.

22. The method of claim 20 wherein the at least one operating parameter comprises at least one of a concentration, pressure, and temperature of at least one of hydrogen, oxygen and nitrogen.

23. The method of claim 21 wherein the magnitude of the at least one operating parameter is detected proximate at least one of the anode flow field plates, an anode recirculation line, an anode fuel inlet positioned between a fuel source and the fuel cell stack, and an anode fuel outlet positioned between the fuel cell stack and the accumulating device.

24. The method of claim 20, further comprising:
detecting a magnitude of at least one operating parameter of the accumulating device proximate at least one of the accumulating device, the first purge control device, and the second purge control device;
comparing the magnitude of the at least one operating parameter of the accumulating device to a second threshold magnitude to determine an existence of the accumulating device purge condition; and
initiating an accumulating device purge when the magnitude of the at least one operating parameter of the accumulating device is substantially identical to or surpasses the second threshold magnitude.

25. The method of claim 24 wherein the at least one operating parameter comprises at least one of a concentration, pressure, and temperature of at least one of hydrogen, oxygen and nitrogen.

26. The method of claim 20, further comprising:
initiating the fuel cell stack purge upon detection of passage of a first threshold duration of time; and
initiating the accumulating device purge upon detection of passage of a second threshold duration of time.

27. The method of claim 20, further comprising:
drawing a primary load from the fuel cell stack.

28. A method of operation of an electrochemical system having a plurality of fuel cells forming a fuel cell stack, each fuel cell comprising a membrane electrode assembly (MEA) having an ion exchange membrane interposed between anode and cathode electrode layers, an anode flow field plate positioned adjacent the anode electrode layer and adapted to direct a hydrogen-containing fuel to the anode electrode layer, a cathode flow field plate positioned adjacent the cathode electrode layer and adapted to direct an oxidant to the cathode electrode layer, at least one accumulating device positioned downstream of the fuel cell stack, a purge control device positioned between the fuel cell stack and the accumulating device, and operable in a first state to allow fluid communication between the anode flow field plates and the accumulating device and in a second state to cease fluid communication between the anode flow field plates and the accumulating device, the method comprising the steps of:
detecting an increase in a load applied to the fuel cell stack and an increase in a magnitude of at least one of a pressure and concentration of the oxidant in the fuel cell stack; and
closing the purge control device for operating in the second state to increase at least one of a pressure and concentration of the hydrogen-containing fuel in the fuel cell stack and balance a pressure differential of the fuel cell stack.

29. A method of operation of an electrochemical system having a plurality of fuel cells forming a fuel cell stack, each fuel cell comprising a membrane electrode assembly (MEA) having an ion exchange membrane interposed between anode and cathode electrode layers, an anode flow field plate positioned adjacent the anode electrode layer and adapted to direct a hydrogen-containing fuel to the anode electrode layer, a cathode flow field plate positioned adjacent the cathode electrode layer and adapted to direct an oxidant to the cathode electrode layer, at least one accumulating device positioned downstream of the fuel cell stack, a purge control device positioned between the fuel cell stack and the accumulating device, and operable in a first state to allow fluid communication between the anode flow field plates and the accumulating device and in a second state to cease fluid communication between the anode flow field plates and the accumulating device, the method comprising the steps of:
detecting a decrease in a load applied to the fuel cell stack and a reduction in a magnitude of at least one of a pressure and concentration of the oxidant in the fuel cell stack; and
opening the purge control device for operating in the first state to reduce at least one of a pressure and concentration of the hydrogen-containing fuel into the fuel cell stack and balance a pressure differential of the fuel cell stack.
